(19) United States
(12) Patent Application Publication
(10) Pub. No.: US 2009/0122069 A1
(43) Pub. Date: May 14, 2009

(54) INFORMATION PROCESSING APPARATUS

(75) Inventors: Masaaki Furusawa, Tokyo (JP); Katsuhiko Ikeda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/266,675

(22) Filed: Nov. 7, 2008

(30) Foreign Application Priority Data
Nov. 12, 2007 (JP) P2007-293626

(51) Int. Cl. G09G 5/02; G09G 3/36

(52) U.S. Cl. 345/589; 345/102

(57) ABSTRACT

A cellular phone includes an illuminance sensor and a controller. The illuminance sensor detects illuminance in an ambient environment of the cellular phone. The controller refers to a control table in which a brightness region corresponding to an illuminance value and a set value related to a brightness value of a backlight are associated with each other and registered in advance. According to an illuminance value detected in the ambient environment, the controller sets a brightness value of the backlight to one of a plurality of set values. If the illuminance value is greater than the previous illuminance value and a brightness region corresponding to the previous illuminance value and a brightness region corresponding to the current illuminance value are different, the controller controls, after a predetermined time elapses, brightness of the backlight according to a set value greater than a set value previously set.

### BACKGROUND OF THE INVENTION

1. Field of the Invention

The present invention relates to information processing apparatuses, and particularly to an information processing apparatus such as a cellular phone capable of controlling a backlight included in a liquid crystal display.

2. Description of the Related Art

In recent years, cellular phones (serving as information processing apparatuses) have provided not only a voice communication function, but also various other functions, such as an address book function, a camera function, an e-mail function via a base station and a network such as the Internet and a browser function allowing a user to view Web pages. Accordingly, for better viewability of a display screen, the size of a liquid crystal display serving as a display unit increases.

In a liquid crystal display included in a mobile terminal, such as a cellular phone, a liquid crystal panel of the liquid crystal display does not emit light itself. Therefore, the liquid crystal panel needs to be illuminated from behind or side of the liquid crystal panel. Typically, such a liquid crystal panel is illuminated from behind by a backlight.

Since the cellular phone is often carried by a user, the liquid crystal display will be used in a dark place such as in a tunnel, as well as in a bright place such as outside. Conventionally, there has been proposed a technique which uses an illuminance sensor (light sensor) capable of detecting illuminance in an environment where a cellular phone is used, so as to control a backlight that illuminates the backside of a liquid crystal panel. Specifically, when the environment where the cellular phone is used is changed to a bright environment, brightness of the backlight that illuminates the backside of the liquid crystal panel is increased, while when the environment where the cellular phone is used is changed to a dark environment, brightness of the backlight that illuminates the backside of the liquid crystal panel is reduced.

Example of techniques related to such backlight control include a known technique in which, when an ambient environment is dark, levels of brightness of a liquid crystal display (LCD) backlight and a key backlight are lowered to minimum brightness levels (see, e.g., Japanese Unexamined Patent Application Publication No. 2006-146030). With the technique proposed in this document, power consumption can be reduced both in bright and dark environments.

With the conventional techniques for backlight control described above, it may be possible to maintain brightness sufficient to use a liquid crystal display. However, if the cellular phone is often used in bright environments, brightness of a backlight illuminating the backside of a liquid crystal panel is often increased. This results in an increase in power consumption associated with use of the backlight.

Particularly in recent years, for the purposes of receiving digital terrestrial broadcast wave, the screen size of liquid crystal displays has been increased. This increases power consumption associated with use of a backlight, and thus reduces battery life in the cellular phone. This problem is not solved by the technique proposed in the document described above.

### SUMMARY OF THE INVENTION

The present invention has been made in view of the circumstances described above. An object of the present invention is to provide an information processing apparatus such as a cellular phone capable of preferably controlling a backlight included in a liquid crystal display.

To solve the problems described above, the present invention provides an information processing apparatus including a liquid crystal display including at least a liquid crystal panel and a backlight; a detecting unit configured to detect illuminance in an environment where the information processing apparatus is used; a setting unit configured to set a brightness value of the backlight turned on when the liquid crystal display displays an image to one of a plurality of set values, on the basis of an illuminance value detected by the detecting unit; and a control unit configured to control brightness of backlight on the basis of the set value set by the setting unit as the brightness value of the backlight, wherein if an illuminance value detected by the detecting unit is greater than the previous illuminance value detected by the detecting unit and a brightness region corresponding to the previous illuminance value and a brightness region corresponding to the current illuminance value are different from each other and then a predetermined time elapses, the setting unit sets the brightness value of the backlight to a set value which is greater by at least one level than a set value in a previous setting processing.

To solve the problems described above, the present invention also provides an information processing apparatus including a liquid crystal display including at least a liquid crystal panel and a backlight; a detecting configured to detect illuminance in an environment where the information processing apparatus is used; a setting unit configured to set a brightness value of the backlight turned on when the liquid crystal display displays an image to one of a plurality of set values, on the basis of an illuminance value detected by the detecting unit, with reference to a control table in which brightness regions corresponding to the illuminance value and set values related to the brightness value of the backlight are associated with each other and registered in advance; and a control unit configured to control brightness of backlight on the basis of the set value set by the setting unit as the brightness value of the backlight, wherein the control unit delays a process of controlling the brightness of the backlight by a predetermined time, on the basis of an illuminance value detected by the detecting unit, if the environment where the information processing apparatus is used is changed to a bright environment. The present invention makes it possible to preferably control a backlight included in a liquid crystal display.

### BRIEF DESCRIPTION OF THE DRAWINGS

FIG. 1A and FIG. 1B are external views of a cellular phone serving as an information processing apparatus according to an embodiment of the present invention.

FIG. 2A and FIG. 2B are other external views of the cellular phone.

FIG. 3 is a block diagram illustrating an internal configuration of the cellular phone.

FIG. 4 shows a backlight control table used in conventional backlight control.

FIG. 5 is a flowchart illustrating a backlight control process in the cellular phone of FIG. 3.

FIG. 6 shows a backlight control table stored in a storage unit illustrated in FIG. 3.

FIG. 7 is a transition diagram showing, in time series, a correspondence between an illuminance value detected by an illuminance sensor and a set value related to brightness of the backlight and used in backlight control.

### DESCRIPTION OF THE PREFERRED EMBODIMENTS

Hereinafter, embodiments of the present invention will be described with reference to the drawings.

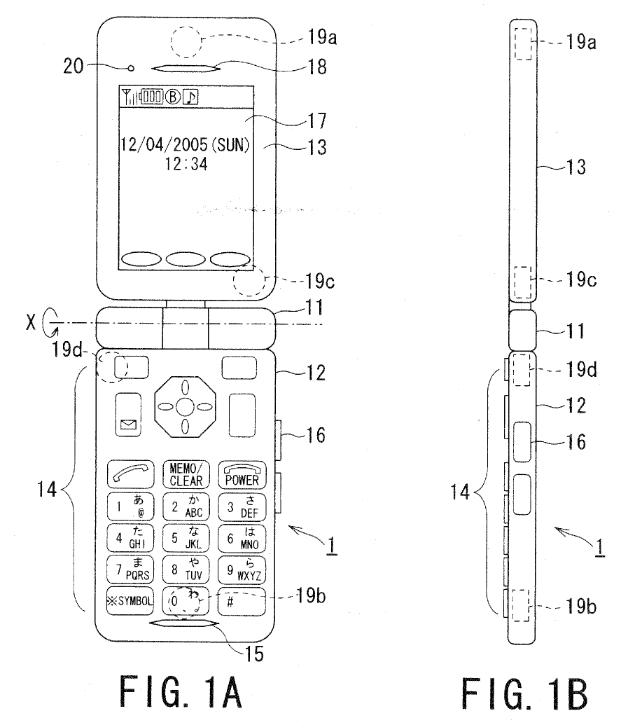

FIG. 1A and FIG. 1B are external views of a cellular phone 1 serving as an information processing apparatus according to an embodiment of the present invention. Specifically, FIG. 1A and FIG. 1B are a front external view and a side external view, respectively, of the cellular phone 1 opened about 180 degrees.

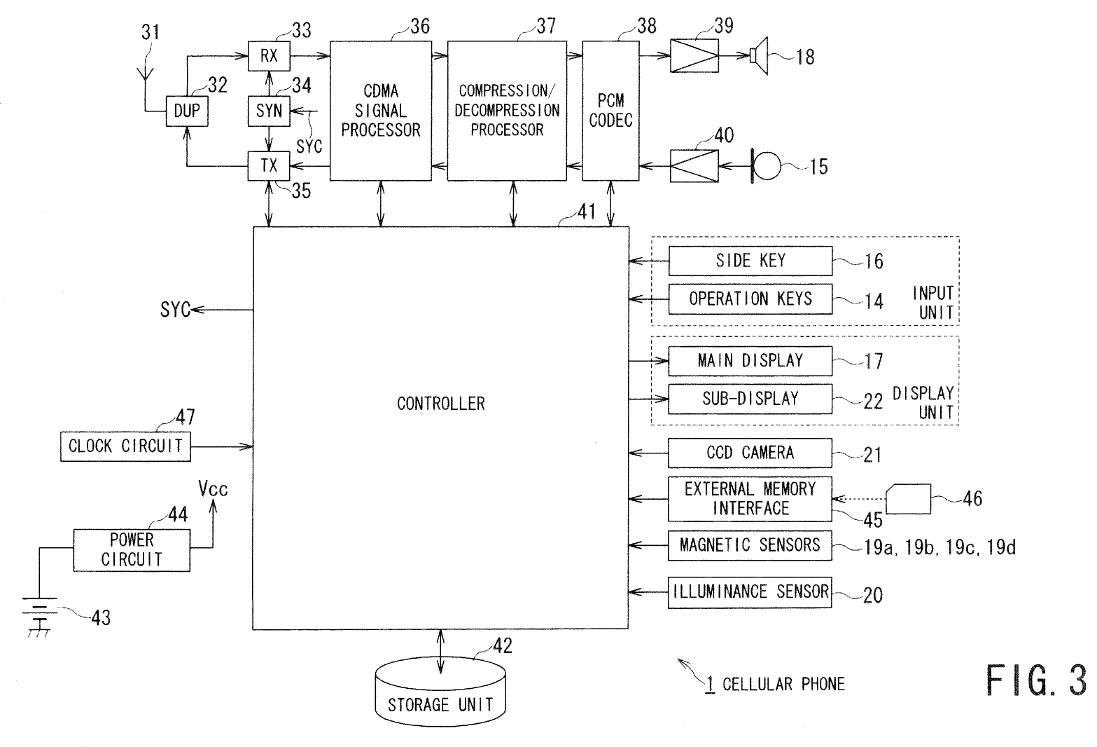

As illustrated in FIG. 1A and FIG. 1B, the cellular phone 1 includes a first housing 12 and a second housing 13 that are hinge-connected to each other with a hinge part 11 in the middle. The cellular phone 1 is formed so as to be foldable in an arrow X direction via the hinge part 11. A transmitting and receiving antenna (an antenna 31 of FIG. 3 described below) is provided at a predetermined position inside the cellular phone 1. The cellular phone 1 may transmit and receive radio waves with a base station (not shown) via this internal antenna.

On the surface of the first housing 12, there are provided operation keys 14, including alphanumeric keys “0” to “9”, a outgoing call key, a redial key, an power key, a redial key, a clear key, and an e-mail key. It is possible to input various instructions by using the operation keys 14.

The operation keys 14 includes a cross key and an confirmation key located in an upper part of the first housing 12. By operating the cross key from side to side and up and down, the user can move a displayed cursor from side to side and up and down. Specifically, various operations, such as scrolling of an address book list, e-mail messages, simplified homepages, and various images displayed on a main display 17 in the second housing 13, are performed.

Pressing the confirmation key allows the user to confirm various functions. For example, when a desired phone number is selected from a plurality of phone numbers on the address book list displayed on the main display 17 according to the user's operation of the cross key, and then, the confirmation key is pressed toward the interior of the first housing 12, the selected phone number is confirmed and an outgoing call processing is performed for the telephone number.

The first housing 12 also has the e-mail key located to the left of the cross key and the confirmation key. When the e-mail key is pressed toward the interior of the first housing 12, e-mail transmission and reception functions are called. The browser key is provided to the right of the cross key and the confirmation key. Pressing the browser key toward the interior of the first housing 12 allows the user to view data on Web pages.

The first housing 12 has a microphone 1S located under the operation keys 14. The microphone 15 collects user's voice during a call. The first housing 12 also has a side key 16 for operating the cellular phone 1.

A battery pack is inserted to be attached on a back surface of the first casing 12. When the power key is turned on, power supplied from the battery pack actuates each circuit.

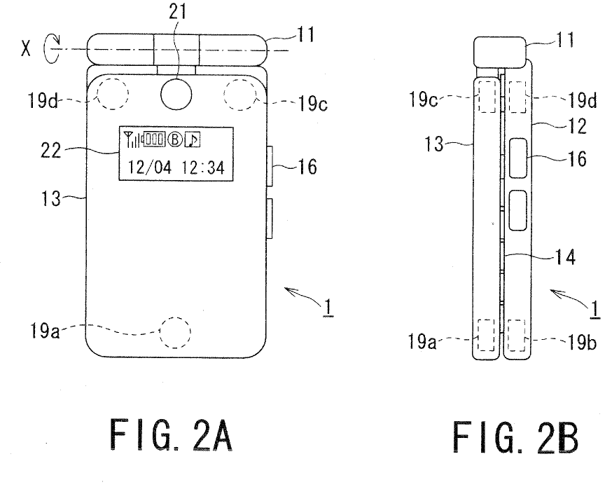

The second housing 13 has the main display 17 on its front surface. The main display 17 displays a reception state of the radio wave, a remaining battery level, destination names and phone numbers registered in the address book, a transmission history, content of e-mail messages, simplified homepages, images picked up by a charge-coupled device (CCD) camera (a CCD camera 21 of FIG. 2 described below), content received from an external content server, and content stored in a memory card (a memory card 46 of FIG. 3 described below). A telephone receiver (earpiece) 18 is provided at a predetermined position above the main display 17. The telephone receiver 18 allows the user to make a voice call. Besides the telephone receiver 18, a speaker serving as a voice output unit is provided at a predetermined position in the cellular phone 1.

Magnetic sensors 19a, 19b, 19c, and 19d for detecting a state of the cellular phone 1 are provided at predetermined positions inside the first housing 12 and second housing 13. Additionally, an illuminance sensor 20 is provided near the telephone receiver 18. For examples the illuminance sensor 20 is a photodiode or a phototransistor and detects illuminance (brightness) in an environment where the cellular phone 1 is used. The main display 17 and a sub-display 22 (described below) are liquid crystal displays. Typically, a liquid crystal display includes a liquid crystal panel, a backlight having cold-cathode tubes, a polarizing filter, an alignment film, electrodes, and an RGB color filter. For example, the backlight is lit by direct lighting or edge lighting.

FIG. 2A and FIG. 2B are other external views of the cellular phone 1. The second housing 13 at the position illustrated in FIG. 1A and FIG. 1B pivots in the direction of arrow X to the position illustrated in FIG. 2A and FIG. 2B. FIG. 2A and FIG. 2B are a front external view and a side external view, respectively, of the cellular phone 1 in a closed state.

The CCD camera 21 is provided in an upper part of the second housing 13. The CCD camera 21 allows the user to pick up an image of a desired target. The sub-display 22 is provided under the CCD camera 21. The sub-display 22 displays an antenna pictogram indicating a current sensitivity level of the antenna, a battery pictogram indicating a current remaining battery level of the cellular phone 1, and current time.

FIG. 3 illustrates an internal configuration of the cellular phone 1. A radio signal transmitted from the base station is received by the antenna 31, passes through an antenna duplexer (DUP) 32, and is input to a receiver (RX) 33. The receiver 33 may perform mixing of the received radio signal with a local oscillation signal output from a frequency synthesizer (SYN) 34 to down-convert the received radio signal into an intermediate frequency signal. Then, the receiver 33 generates a reception baseband signal by performing a quadrature demodulation (quadrature detection) on the down-converted intermediate frequency signal. The receiver 33 outputs the generated baseband signal to a CDMA signal processor 36. The frequency of the local oscillation signal generated from the frequency synthesizer 34 is indicated by a control signal SYC output from a controller 41.

The CDMA signal processor 36 is provided with a RAKE receiver. In the RAKE receiver, a plurality of paths included in the reception baseband signal are de-spread with respective spread codes (i.e., spread codes equivalent to those of the spread reception signals). Then, after the phase in the despread signals of the respective paths is adjusted, the despread signals of the respective paths are coherently RAKE-combined by the RAKE receiver. A data series obtained through the Rake combining is subjected to de-interleaving, channel decoding (error correction decoding) and binary data determination. Thus, reception packet data in a predetermined transmission format can be obtained. The reception packet data is input to a compression/decompression processor 37.

The compression/decompression processor 37 is composed of a digital signal processor (DSP). The compression/decompression processor 37 separates the reception packet data output from the CDMA signal processor 36 in a multiplexer/demultiplexer for each media, and perform a decoding processing on the separated data for each media. For example, in a call mode, speech data included in the reception packet data and corresponding to spoken voice is decoded by a speech codec. If video data is included in the reception packet data, such as in the case of a videophone mode, the video data is decoded by a video codec. For example, if the reception packet data is downloaded content, the downloaded content is decompressed (expanded) and output to the controller 41.

A digital speech signal obtained by decoding is supplied to a PCM codec 38, The PCM codec 38 PCM-decodes the digital speech signal output from the compression/decompression processor 37, and outputs an analog speech signal obtained by the PCM decoding to a receiving amplifier 39. The analog speech signal is amplified by the receiving amplifier 39 and output by the telephone receiver 1B.

A digital video signal obtained through decoding performed by the compression/decompression processor 37 at the video codec is input to the controller 41. The controller 41 causes the main display 17 to display, via a video RAM such as a VRAM, a video image based on the digital video signal output from the compression/decompression processor 37. The controller 41 causes the main display 17 to display, via the RAM, not only a received video data but also a video data picked up by the CC camera 21.

If the reception packet data is an e-mail message, the compression/decompression processor 37 supplies the e-mail message to the controller 41. The controller 41 causes a storage unit 42 to store the e-mail message supplied from the compression/decompression processor 37. Then, in response to the user's operation of the operation keys 14 included in an input unit, the controller 41 reads the e-mail message stored in the storage unit 42 and causes the main display 17 to display the read e-mail message.

On the other hand, in the call mode, a speaker's (user's) speech signal (analog speech signal) input to the microphone 15 is amplified to a proper level by a transmitting amplifier 40 and PCM-coded by the PCM-codec 38. A digital speech signal obtained by the PCM coding is input to the compression/decompression processor 37. A video signal output from the CCD camera 21 is digitized by the controller 41 and input to the compression/decompression processor 37. An e-mail message, which is text data generated by the controller 41, is also input to the compression/decompression processor 37.

The compression/decompression processor 37 may compression-code the digital speech signal from the PCM codec 38 in a format corresponding to a predetermined transmission data rate. Thus, speech data is generated. Also, the compression/decompression processor 37 compression-codes the digital video signal from the controller 41 so as to generate video data. Then, the compression/decompression processor 37 causes the multiplexer/demultiplexer to multiplex the speech data and the video data into transmission packet data in accordance with a predetermined transmission format. The compression/decompression processor 37 packetizes the data multiplexed in the multiplexer/demultiplexer. The compression/decompression processor 37 outputs the transmission packet data after the packetization to the CDMA signal processor 36. When an e-mail message is output from the controller 41, the compression/decompression processor 37 similarly causes the multiplexer/demultiplexer to multiplex the e-mail message into transmission packet data.

The CDMA signal processor 36 uses a spread code assigned to a transmission channel to perform spread spectrum processing on the transmission packet data output from the compression/decompression processor 37, and outputs an output signal generated by the spread spectrum processing to a transmitter (TX) 35. The transmitter 35 modulates the signal after the spread spectrum processing by using a digital modulation method such as a QPSK (Quadrature Phase Shift Keying) method. The transmitter 35 synthesizes the transmission signal after the digital modulation with the local oscillator signal generated from the frequency synthesizer 34 to up-convert the transmission signal into the radio signal. Then, the transmitter 35 high-frequency-amplifies the radio signal generated by the up-conversion so as to obtain the transmission power level indicated by the controller 41. The high-frequency-amplified radio signal is supplied via the antenna duplexer 32 to the antenna 31, and is transmitted from the antenna 31 to the base station.

The cellular phone 1 has an external memory interface 45, which has a slot allowing insertion and withdrawal of the memory card 46. The memory card 46 is a type of flash memory card typified by a NAND flash memory card and a NOR flash memory card. Various types of data, such as images, speech, and music can be written to and read from the memory card 46 via a 10-pin terminal. The cellular phone 1 further has a clock circuit (timer) 47 for accurate measurement of the current time.

The controller 41 includes a central processing unit (CPU), a read only memory (ROM), and a random access memory (RAM). The CPU performs various types of processing according to a program stored in the ROM or various application programs loaded from the storage unit 42 to the RAM, generates various control signals, supplies the control signals to various sections, and thus controls the overall operation of the cellular phone 1. The RAM stores data necessary for the CPU to perform various types of processing.

The storage unit 42 is composed of a hard disk drive (HDD) or a flash memory device, which is a nonvolatile memory allowing electrical writing and erasing. The storage unit 42 stores various data groups and various application programs to be executed by the CPU in the controller 41. A power circuit 44 generates a predetermined operating supply voltage Vcc on the basis of an output from a battery 43 and supplies the operating supply voltage Vcc to each circuit unit.

In conventional techniques for backlight control, the illuminance sensor 20 is used to control the backlight which illuminates the backside (or side) of a liquid crystal panel. For example, when the user opens the cellular phone 1 or presses any of the operation keys 14 on the cellular phone 1 in a closed or open state, the backlight for the liquid crystal display (including the main display 17 and the sub-display 22) lights up. Then, when the backlight lights up, an illuminance value (sensor value) detected by the illuminance sensor 20 and indicating illuminance (brightness) in an environment where the cellular phone 1 is used is read from the illuminance sensor 20 every predetermined time (e.g., every one or two seconds). Then, according to the read illuminance value and a predetermined reference value related to the illuminance, the brightness of the liquid crystal display (including the main display 17 and the sub-display 22) is controlled. The main display 17 and the sub-display 22 may be controlled either together or independently.

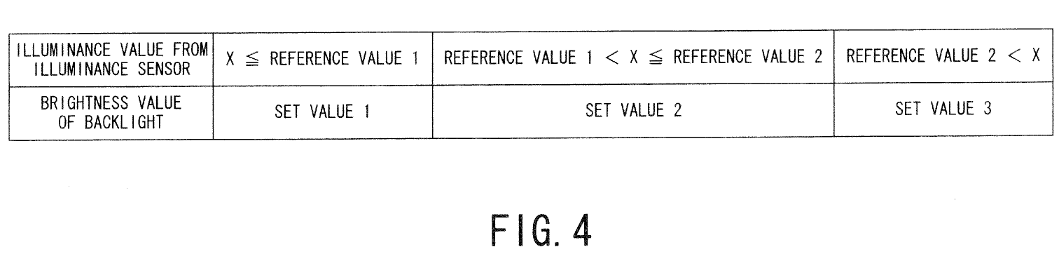

For example, reference value 1 and reference value 2 (reference value 1<reference value 2) are set as predetermined values related to illuminance. In this case, as shown in FIG. 4, if an illuminance value read from the illuminance sensor 20 is less than or equal to reference value 1, the brightness of the backlight is controlled to be set value 1 (i.e., a set value related to the brightness of the backlight). If an illuminance value read from the illuminance sensor 20 is greater than reference value 1 and less than or equal to reference value 2, the brightness of the backlight is controlled to be set value 2. If an illuminance value read from the illuminance sensor 20 is greater than reference value 2, the brightness of the backlight is controlled to be set value 3. Here, set values 1 to 3 satisfy the following relationship: set value 1<set value 2<set value 3.

In the backlight control described above, according to the detection result from the illuminance sensor 20, the brightness of the backlight is controlled every predetermined time. Specifically, if the environment where the cellular phone 1 is used is changed to a bright environment, the brightness of the backlight illuminating the backside of the liquid crystal panel is immediately increased; and if the environment where the cellular phone 1 is used is changed to a dark environment, the brightness of the backlight illuminating the backside of the liquid crystal panel is immediately reduced.

With the conventional techniques for backlight control, it may be possible to maintain brightness sufficient to use the liquid crystal display (including the main display 17 and the sub-display 22). However, if the cellular phone 1 is often used in bright environments, the brightness of the backlight illuminating the backside of the liquid crystal panel often reaches a maximum set value. This increases power consumption associated with use of the backlight.

If a predetermined time (wait time) used for backlight control is set to be longer than usual, it may be possible to reduce such an increase in power consumption. However, with this method, when the environment where the cellular phone 1 is used is changed to a dark environment, the brightness of the backlight is not immediately reduced and power is wasted. As a result, it becomes difficult to effectively reduce power consumption associated with use of the backlight.

Therefore, control is performed such that when the environment where the cellular phone 1 is used is changed to a bright environment, the timing at which the brightness of the backlight is increased is delayed, while when the environment where the cellular phone 1 is used is changed to a dark environment, the brightness of the backlight is immediately reduced. In other words, every time illuminance in the environment where the cellular phone 1 is used is changed, different backlight control is performed according to a change to a dark environment or a change to a bright environment (that is, according to a transition direction of the environment where the cellular phone 1 is used). This makes it possible to preferably control the backlight in the liquid crystal display. Hereinafter, a backlight control process based on this method will be described.

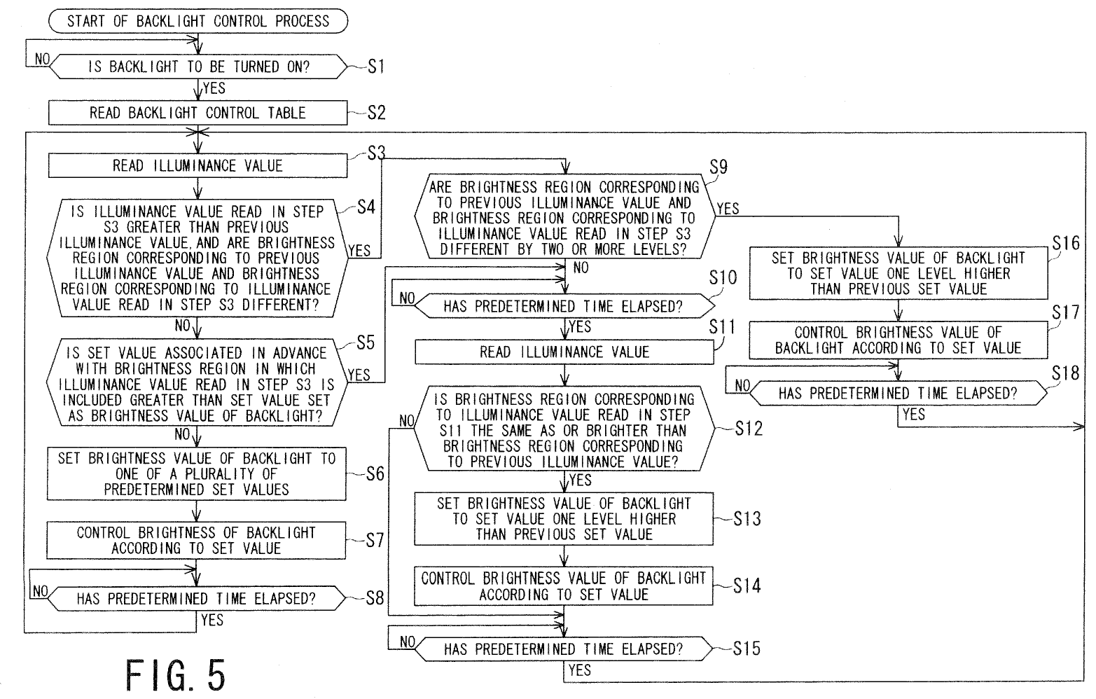

With reference to the flowchart of FIG. 5, a backlight control process performed in the cellular phone 1 of FIG. 3 will be described. This backlight control process starts when the user operates the cellular phone 1. For example, the backlight control process starts when the user opens the cellular phone 1, the magnetic sensors 19a to 19d detect the opening, and the controller 41 receives the detected signal. Alternatively, the backlight control process may start when the user presses any of the operation keys 14 on the cellular phone 1 in the closed or open state and the controller 41 detects the pressing. Although the flowchart of FIG. 5 illustrates backlight control for the main display 17, the present invention is applicable to backlight control for the sub-display 22.

In step S1 the controller 41 uses the magnetic sensors 19a to 19d to monitor whether the cellular phone 1 in the closed state is opened, or the controller 41 monitors whether any of the operation keys 14 on the cellular phone 1 in the closed or open state is pressed. Then, the controller 41 determines whether to turn on the backlight for the main display 17. The controller 41 waits until it determines that the backlight is to be turned on.

When the controller 41 determines in step S1 that the backlight for the main display 17 is to be turned on, the process proceeds to step S2, where the controller 41 reads a backlight control table stored in the storage unit 42.

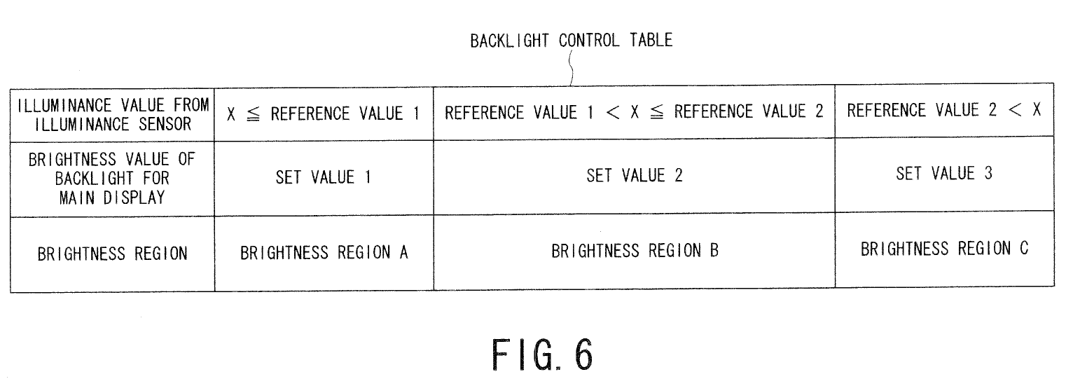

FIG. 6 shows a configuration of a backlight control table stored in the storage unit 42. For example, as shown in FIG. 6, reference value 1 and reference value 2 (reference value 1<reference value 2) are set as predetermined reference values related to illuminance. If it is determined that an illuminance value read from the illuminance sensor 20 is less than or equal to reference value 1, the controller 41 sets the brightness of the backlight for the main display 17 to set value 1 (a set value related to brightness of the backlight). If it is determined that an illuminance value read from the illuminance sensor 20 is greater than reference value 1 and less than or equal to reference value 2, the controller 41 sets the brightness of the backlight to set value 2. If it is determined that an illuminance value read from the illuminance sensor 20 is greater than reference value 2, the controller 41 sets the brightness of the backlight to set value 3. Here, set values 1 to 3 satisfy the following relationship: set value 1<set value 2<set value 3. A brightness region indicating brightness in the environment where the cellular phone 1 is used is classified into brightness region A, brightness region B, or brightness region C according to the illuminance value (x≦reference value 1, reference value 1<x≦reference value 2, or reference value 2<x) read from the illuminance sensor 20. More specifically, brightness region A represents a dark place where there is no light, brightness region B represents a room lit by a fluorescent lamp, and brightness region C represents an outdoor place under sunlight. It is obvious that it is possible to provide three or more predetermined reference values related to illuminance, four or more brightness regions corresponding to the reference values, and four or more set values related to the brightness of the backlight.

Here, the term “brightness” means brightness per unit area of a light-emitting body (e.g., the backlight for the main display 17).

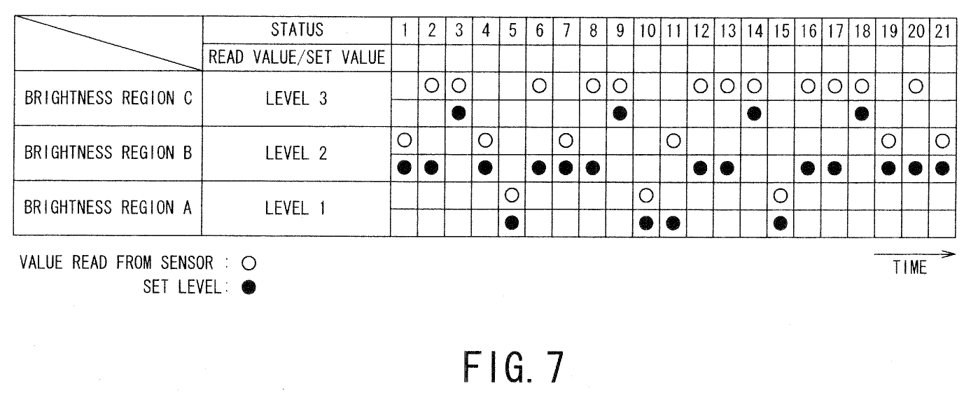

FIG. 7 is a transition diagram (hysteresis) showing, in time series, a correspondence between an illuminance value detected by the illuminance sensor 20 and a set value related to brightness of the backlight and used in backlight control. The correspondence shown in FIG. 7 is used to describe the backlight control process shown by the flowchart of FIG. 5. Here, for example, the current status of the cellular phone 1 is a status immediately before status 1 of FIG. 7, an illuminance value read from the illuminance sensor 20 is greater than reference value 1 and less than or equal to reference value 2 and is included in brightness region B, and an brightness value related to brightness of the backlight and used in backlight control is set to set value 2. Then, in step S3 described below, the current status of the cellular phone 1 is changed to status 1 shown in FIG. 7.

In step S3, the controller 41 reads, from the illuminance sensor 20, an illuminance value detected by the illuminance sensor 20 near the telephone receiver 18 and related to illuminance (brightness) in an environment where the cellular phone 1 is used. For example, as shown in status 1 of FIG. 7, the illuminance value read from the illuminance sensor 20 is greater than reference value 1 and less than or equal to reference value 2, and is included in brightness region B (as indicated by a white circle in status 1 of FIG. 7). Here, the term “illuminance” means the luminous flux per unit area on an illuminated surface of the illuminance sensor 20.

In step S4, the controller 41 refers to the predetermined reference values (reference value 1 and reference value 2) related to illuminance and described in the backlight control table read from the storage unit 42, and also refers to the previous illuminance value previously read and stored in a memory (RAM). Then, the controller 41 determines whether the illuminance value read from the illuminance sensor 20 in step S3 is greater than the previous illuminance value, and whether a brightness region corresponding to the previous illuminance value and a brightness region corresponding to the illuminance value read in step S3 are different from each other.

For example, if the illuminance value read in step S3 is smaller than the previous illuminance value, or if the illuminance value read in step S3 is greater than the previous illuminance value but the brightness region corresponding to the previous illuminance value and the brightness region corresponding to the illuminance value read in step S3 are the same, it is determined to be “NO” in step S4.

In status 1 shown in FIG. 7, the illuminance value read from the illuminance sensor 20 in step S3 is greater than reference value 1 and less than or equal to reference value 2, and is included in brightness region B, which is the same as the brightness region in the previous status. That is, the brightness region (brightness region B) corresponding to the previous illuminance value and the brightness region (brightness region B) corresponding to the illuminance value read in step S3 are the same. Therefore, it is determined to be “NO” in step S4.

Then, the process proceeds to step S5, where the controller 41 refers to the backlight control table read from the storage unit 42 to determine whether a set value (e.g., set value 1, 2, or 3) associated in advance with the brightness region (e.g., brightness region A, B, or C) in which the illuminance value read from the illuminance sensor 20 in step S3 is included is greater than the set value currently set as a brightness value of the backlight.

In the case of status 1 of FIG. 7, the brightness value related to brightness of the backlight and used in backlight control has already been set to set value 2 in the status immediately before status 1. At the same time, the set value associated in advance with brightness region B in which the illuminance value read from the illuminance sensor 20 in step S3 is included is set value 2. Therefore, it is determined in step S5 that the set value associated in advance with the brightness region in which the illuminance value read from the illuminance sensor 20 in step S3 is included is the same as (or not greater than) the set value currently set as a brightness value of the backlight.

If it is determined in step S5 that the set value associated in advance with the brightness region in which the illuminance value read from the illuminance sensor 20 in step S3 is included is not greater than (or is the same as or less than) the set value currently set as a brightness value of the backlight, the process proceeds to step S6. In step S6, the controller 41 refers to the backlight control table read from the storage unit 42 to set the brightness value of the backlight for the main display 17 to a set value (e.g., set value 1, 2, or 3) associated in advance with the brightness region (e.g., brightness region A, B, or C) in which the illuminance value read from the illuminance sensor 20 in step is included.

For example, in status 1 of FIG. 7, the set value associated in advance with brightness region B in which the illuminance value read from the illuminance sensor 20 in step S3 is included is set value 2. Therefore, the brightness value of the backlight for the main display 17 is set to set value 2 (as indicated by a black circle in status 1 of FIG. 7).

In step S7, the controller 41 controls the main display 17 to control the brightness of the backlight for the main display 17 according to the set value set as the brightness value of the backlight in step S6. In step S8, on the basis of information output from the clock circuit 47, the controller 41 determines whether a predetermined time (e.g., 0.5, 1, or 2 seconds) has elapsed. The controller 41 waits until it determines that the predetermined time has elapsed.

If it is determined in step S8 that the predetermined time has elapsed, the controller μl performs control to store the illuminance value read in step S3 in the memory (RAM). Then, the process returns to step S3 and the steps following step S3 are repeated. That is, the current status of the cellular phone 1 is changed from status 1 to status 2 shown in FIG. 7. In status 2 of FIG. 7, the environment where the cellular phone 1 is used is brighter than the environment in status 1. Then, in step S3, an illuminance value is read from the illuminance sensor 20. For example, as shown in status 2 of FIG. 7, a brightness region corresponding to the illuminance value read from the illuminance sensor 20 in step S3 is brightness region C (as indicated by a white circle in status 2 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other.

In the case of status 2 in FIG. 7, the illuminance value read from the illuminance sensor 20 in step S3 is greater than reference value 2 and is included in brightness region C, which is brighter than brightness region B in status 1 of FIG. 7. That is, the brightness region (brightness region B) corresponding to the previous illuminance value and the brightness region (brightness region C) corresponding to the illuminance value read in step S3 are different from each other. Therefore, it is determined to be “YES” in step S4.

If it is determined in step S4 that the illuminance value read in step S3 is greater than the previous illuminance value and the brightness region corresponding to the previous illuminance value and the brightness region corresponding to the illuminance value read in step S3 are different from each other (YES in step S4), the process proceeds to step S9. In step S9, the controller 41 determines whether the brightness region corresponding to the previous illuminance value and the brightness region corresponding to the illuminance value read in step S3 are different from each other by two or more levels. For example, in the case of status 2 in FIG. 7, the brightness region corresponding to the previous illuminance value is brightness region B, while the brightness region corresponding to the illuminance value read in step S3 is brightness region C. Since brightness region B and brightness region C are not different from each other by two or more levels, the controller 41 determines in step S9 that the brightness region corresponding to the previous illuminance value and the brightness region corresponding to the illuminance value read in step S3 are not different from each other by two or more levels.

If it is determined in step S9 that the brightness region corresponding to the previous illuminance value and the brightness region corresponding to the illuminance value read in step S3 are not different from each other by two or more levels (“NO” in step S9), the process proceeds to step S10. In step S10, the controller 41 uses the clock circuit 47 to determine whether a predetermined time (e.g., 0.5, 1, or 2 seconds) has elapsed. The controller 41 waits until it determines that the predetermined time has elapsed. It should be noted that the brightness of the backlight for the main display 17 is maintained at the set value in a previous setting processing until the predetermined time elapses.

If it is determined in step S10 that the predetermined time has elapsed, the current status of the cellular phone 1 is changed from status 2 to status 3 shown in FIG. 7. Then, in step S11, the controller 41 reads, from the illuminance sensor 20, an illuminance value detected by the illuminance sensor 20 near the telephone receiver 18 and related to illuminance (brightness) in an environment where the cellular phone 1 is used. For example, as shown in status 3 of FIG. 7, as in the case of status 2 of FIG. 7, the illuminance value read from the illuminance sensor 20 is greater than reference value 2 and is included in brightness region C (as indicated by a white circle in status 3 of FIG. 7).

In step S12, the controller 41 determines whether the brightness region corresponding to the illuminance value read from the illuminance sensor 20 in step S11 is the same as or brighter than the brightness region corresponding to the previous illuminance value.

For example, in the case of status 3 in FIG. 7, the brightness region corresponding to the illuminance value read from the illuminance sensor 20 is brightness region C, as in the case of status 2 of FIG. 7. Therefore, the controller 41 determines that the brightness region corresponding to the illuminance value read from the illuminance sensor 20 is the same as the brightness region corresponding to the previous illuminance value.

If it is determined in step S12 that the brightness region corresponding to the illuminance value read in step S11 is the same as or brighter than the brightness region corresponding to the previous illuminance value (“YES” in step S12), the process proceeds to step S13. In step S13, the controller 41 refers to the read backlight control table to set the brightness value of the backlight for the main display 17 to a set value that is one level higher than the set value previously set as the brightness value of the backlight.

For example, in the case of status 3 in FIG. 7, the set value that is one level higher than set value 2 previously set in status 2 and associated in advance with brightness region B is set value 3. Therefore, the brightness value of the backlight for the main display 17 is set to set value 3 (as indicated by a black circle in status 3 of FIG. 7).

In step S14, the controller 41 controls the main display 17 to control the brightness of the backlight for the main display 17 according to the set value set as the brightness value of the backlight in step S13.

In step S15, the controller 41 uses the clock circuit 47 to determine whether a predetermined time (e.g., 0.5, 1, or 2 seconds) has elapsed. The controller 41 waits until it determines that the predetermined time has elapsed.

If it is determined in step S15 that the predetermined time has elapsed, the process returns to step S3 and the steps following step S3 are repeated. That is, the current status of the cellular phone 1 is changed from status 3 to status 4 shown in FIG. 7. In status 4 of FIG. 7, the environment where the cellular phone 1 is darker than that in status 3. Then, in step S3, an illuminance value is read from the illuminance sensor 20. For example, as shown in status 4 of FIG. 7, a brightness region corresponding to the illuminance value read from the illuminance sensor 20 is brightness region B (as indicated by a white circle in status 4 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other.

In the case of status 4 in FIG. 7, the illuminance value read from the illuminance sensor 20 in step S3 is smaller than the previous illuminance value. Therefore, it is determined to be “NO” in step S4.

Then, in the process of step S6 and step S7, the brightness value of the backlight for the main display 17 is set to set value 2, and the brightness of the backlight for the main display 17 is controlled according to set value 2. If it is determined in step S8 that the predetermined time has elapsed, the process returns to step S3 and the current status of the cellular phone 1 is changed from status 4 to status 5. In status 5 of FIG. 7, as in the case of status 4, the environment where the cellular phone 1 is used is darker than that in status 4.

Then, in the process of step S3 to step S8, the brightness value of the backlight for the main display 17 is set to set value 1, and the brightness of the backlight for the main display 17 is controlled according to set value 1. If it is determined in step S3 that the predetermined time has elapsed, the process returns to step S3 and the current status of the cellular phone 1 is changed from status 5 to status 6. In status 6 of FIG. 7, unlike in the case of status 5, the environment where the cellular phone 1 is brighter than that in status 5.

Then, in step S3, an illuminance value is read from the illuminance sensor 20. For example, as shown in status 6 of FIG. 7, the illuminance value read from the illuminance sensor 20 is greater than reference value 2 and is included in brightness region C (as indicated by a white circle in status 6 of FIG. 7).

Next, in step S4, the controller 41 determines whether the illuminance value read from the illuminance sensor 20 in step S3 is greater than the previous illuminance value, and the brightness region corresponding to the previous illuminance value and the brightness region corresponding to the illuminance value read in step S3 are different from each other.

In the case of status 6 in FIG. 7, the brightness region corresponding to the illuminance value read from the illuminance sensor 20 in step S3 is brightness region C, which is brighter than brightness region A in status 5 of FIG. 7. Therefore, it is determined to be “YES” in step S4.

Then in step S9, it is determined whether the brightness region corresponding to the previous illuminance value and the brightness region corresponding to the illuminance value read in step S3 are different from each other by two or more levels. In the transition from status 5 to status 6 in FIG. 7, brightness region A is changed to brightness region C, which is different by two levels from brightness region A. Therefore, it is determined in step S9 that the brightness region corresponding to the previous illuminance value and the brightness region corresponding to the illuminance value read in step S3 are different from each other by two or more levels (“YES” in step S9).

Then, if it is determined that the brightness region corresponding to the previous illuminance value and the brightness region corresponding to the illuminance value read in step S3 are different from each other by two or more levels (“YES” in step S9), the process proceeds to step S16. In step S16, the controller 41 refers to the read backlight control table to set the brightness value of the backlight for the main display 17 to a set value that is one level higher than the set value previously set as the brightness value of the backlight. For example, in the case of status 6 shown in FIG. 7, the set value that is one level higher than set value 1 associated in advance with brightness region A previously set in status 5 is set value 2. Therefore, the brightness value of the backlight for the main display 17 is set to set value 2 (as indicated by a black circle in status 6 of FIG. 7).

In step S17, the controller 41 controls the main display 17 to control the brightness of the backlight for the main display 17 according to the set value set as the brightness value of the backlight in step S16. In step S18, the controller 41 uses the clock circuit 47 to determine whether a predetermined time (e.g., 0.5, 1, or 2 seconds) has elapsed. The controller 41 waits until it determines that the predetermined time has elapsed.

If it is determined in step S18 that the predetermined time has elapsed, the process returns to step S3 and the steps following step S3 are repeated. That is, the current status of the cellular phone 1 is changed from status 6 to status 7 shown in FIG. 7. In status 7 of FIG. 7, the environment where the cellular phone 1 is used is darker than that in status 6. Then, in step S3, an illuminance value is read from the illuminance sensor 20. For example, as shown in status 7 of FIG. 7, the illuminance value read from the illuminance sensor 20 is greater than reference value 1 and less than or equal to reference value 2, and is included in brightness region B (as indicated by a white circle in status 7 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 7 in FIG. 7, the illuminance value read from the illuminance sensor 20 in step S3 is greater than reference value 1 and less than or equal to reference value 2, and is included in brightness region B, which is darker than brightness region C in status 6 of FIG. 7. Then, since the illuminance value read from the illuminance sensor 20 in step S3 is smaller than the previous illuminance value, it is determined to be “NO” in step S4.

Then, in the process of step S6 and step S7, the brightness value of the backlight for the main display 17 is set to set value 2, and the brightness of the backlight for the main display 17 is controlled according to set value 2. If it is determined in step S8 that the predetermined time has elapsed, the process returns to step S3 and the current status of the cellular phone 1 is changed from status 7 to status 8. In status 8 of FIG. 7, the environment where the cellular phone 1 is used is brighter than that in status 7. As in the case of status 2 and status 3 in FIG. 7, the process in step S4 and steps S9 to S14 is performed. That is, after the brightness value of the backlight for the main display 17 is temporarily maintained at set value 2 (as indicated by a black circle in status 8 of FIG. 7) and a predetermined time elapses, the brightness value of the backlight for the main display 17 is set to set value 3 (as indicated by a black circle in status 9 of FIG. 7).

Then, in step S14, the brightness of the backlight for the main display 17 is controlled according to the set value set as the brightness value of the backlight in step S13. If it is determined in step S15 that a predetermined time has elapsed, the process returns to step S3 and the steps following step S3 are repeated. That is, the current status of the cellular phone 1 is changed from status 9 to status 10 shown in FIG. 7. In status 10 of FIG. 7, the environment where the cellular phone 1 is used is darker than that in status 9.

Then, in step S3, an illuminance value is read from the illuminance sensor 20. For example, as shown in status 10 of FIG. 7, a brightness region corresponding to the illuminance value read from the illuminance sensor 20 is brightness region A (as indicated by a white circle in status 10 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 10 in FIG. 7, the illuminance value read from the illuminance sensor 20 in step S3 is less than or equal to reference value 1 and is included in brightness region A, which is darker than brightness region C in status 9 of FIG. 7. Then, since the illuminance value read from the illuminance sensor 20 in step S3 is smaller than the previous illuminance value, it is determined to be “NO” in step S4. Then, in the process of step S6 and step S7, the brightness value of the backlight for the main display 17 is set to set value 1, and the brightness of the backlight for the main display 17 is controlled according to set value 1.

If it is determined in step S8 that a predetermined time has elapsed, the process returns to step S3 and the current status of the cellular phone 1 is changed from status 10 to status 11. In status 11 of FIG. 7, the environment where the cellular phone 1 is used is brighter than that in status 10. Then, in step S3, an illuminance value is read from the illuminance sensor 20. For example, as shown in status 11 of FIG. 7, a brightness region corresponding to the illuminance value read from the illuminance sensor 20 is brightness region B (as indicated by a white circle in status 11 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 11 in FIG. 7, the illuminance value read from the illuminance sensor 20 in step S3 is greater than reference value 1 and less than or equal to reference value 2, and is included in brightness region B, which is brighter than brightness region A in status 10 of FIG. 7. Then, since the brightness region (brightness region A) corresponding to the previous illuminance value and the brightness region (brightness region B) corresponding to the illuminance value read in step S3 are different from each other, it is determined to be “YES” in step S4.

If it is determined in step S4 that the illuminance value read in step S3 is greater than the previous illuminance value and the brightness region corresponding to the previous illuminance value and the brightness region corresponding to the illuminance value read in step S3 are different from each other (“YES” in step S4), the process proceeds to step S9. In step S9, the controller 41 determines whether the brightness region corresponding to the previous illuminance value and the brightness region corresponding to the illuminance value read in step S3 are different from each other by two or more levels. For example, in the case of status 11 in FIG. 7, there is transition from brightness region A to brightness region B, which is one level different from brightness region A. Therefore, the controller 41 determines in step S9 that the brightness region corresponding to the previous illuminance value and the brightness region corresponding to the illuminance value read in step S3 are not different from each other by two or more levels.

If it is determined in step S9 that the brightness region corresponding to the previous illuminance value and the brightness region corresponding to the illuminance value read in step S3 are not different from each other by two or more levels (“NO” in step S9), the process proceeds to step S10. In step S10, the controller 41 uses the clock circuit 47 to determine whether the predetermined time has elapsed. If it is determined in step S10 that the predetermined time has elapsed, the current status of the cellular phone 1 is changed from status 11 to status 12 shown in FIG. 7. Then, in step S11, the controller 41 reads, from the illuminance sensor 20, an illuminance value detected by the illuminance sensor 20 near the telephone receiver 18 and related to illuminance (brightness) in the environment where the cellular phone 1 is used. For example, as shown in status 12 of FIG. 7, the brightness region corresponding to the illuminance value read from the illuminance sensor 20 is brightness region C (as indicated by a white circle in status 12 of FIG. 7).

In step S12, the controller 41 determines whether the brightness region corresponding to the illuminance value read from the illuminance sensor 20 in step S11 is the same as or brighter than the brightness region corresponding to the previous illuminance value. For example, in the case of status 12 in FIG. 7, the brightness region corresponding to the illuminance value read from the illuminance sensor 20 is brightness region C, which is one level brighter than brightness region B in the case of status 11 of FIG. 7. Therefore, it is determined in step S12 that the brightness region corresponding to the illuminance value read from the illuminance sensor 20 is brighter than the brightness region corresponding to the previous illuminance.

If it is determined in step S12 that the brightness region corresponding to the illuminance value read in step S11 is the same as or brighter than the brightness region corresponding to the previous illuminance value (“YES” in step S12), the process proceeds to step S13. In step S13, the controller 41 refers to the read backlight control table to set the brightness value of the backlight for the main display 17 to a set value that is one level higher than the set value previously set as the brightness value of the backlight. For example, in status 12 of FIG. 7, the set value that is one level higher than set value 1 previously set in status 11 and associated in advance with brightness region A is set value 2. Therefore, the brightness value of the backlight for the main display 17 is set to set value 2 (as indicated by a black circle in status 12 of FIG. 7). In step S14, the controller 41 controls the main display 17 to control the brightness of the backlight for the main display 17 according to the set value set as the brightness value of the backlight in step S13.

If it is determined in step S15 that a predetermined time has elapsed, the current status of the cellular phone 1 is changed from status 12 to status 13 shown in FIG. 7. In status 13 of FIG. 7, the environment where the cellular phone 1 is used is brightness region C, which is the same as that in status 12 of FIG. 7. Then, in step S3, an illuminance value is read from the illuminance sensor 20. For example, as shown in status 13 of FIG. 7, a brightness region corresponding to the illuminance value read from the illuminance sensor 20 is brightness region C (as indicated by a white circle in status 13 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 13 in FIG. 7, the illuminance value read from the illuminance sensor 20 is greater than reference value 2 and is included in brightness region C, which is the same as that in status 12 of FIG. 7. That is, the brightness region (brightness region C) corresponding to the previous illuminance value and the brightness region (brightness region C) corresponding to the illuminance value read in step S3 are the same. Therefore, regardless of whether the illuminance value read in step S3 is greater than the previous illuminance value, it is determined to be “NO” in step S4.

Then, the process proceeds to step S5, where the controller 41 refers to the read backlight control table to determine whether a set value associated in advance with the brightness region in which the illuminance value read from the illuminance sensor 20 is included is greater than the set value currently set as a brightness value of the backlight.

In the case of status 13 in FIG. 7, the brightness value related to brightness of the backlight and used in backlight control has already been set to set value 2 in status 12 of FIG. 7, and the set value associated in advance with brightness region C in which the illuminance value read from the illuminance sensor 20 is included is set value 3. Therefore, it is determined in step S5 that the set value associated in advance with the brightness region in which the illuminance value read from the illuminance sensor 20 is included is greater than the set value currently set as a brightness value of the backlight.

If it is determined in step S5 that the set value associated in advance with the brightness region in which the illuminance value read from the illuminance sensor 20 is included is greater than the set value currently set as a brightness value of the backlight (“YES” in step S5), the process proceeds to step S10, where it is determined whether a predetermined time has elapsed.

If it is determined in step S10 that the predetermined time has elapsed, the current status of the cellular phone 1 is changed from status 13 to status 14 shown in FIG. 7. In status 14 of FIG. 7, the environment where the cellular phone 1 is used is brightness region C, which is the same as that in status 13 of FIG. 7. Then, in step S11, an illuminance value is read from the illuminance sensor 20. For example, as shown in status 14 of FIG. 7, a brightness region corresponding to the illuminance value read from the illuminance sensor 20 is brightness region C (as indicated by a white circle in status 14 of FIG. 7).

Next, in step S19, the controller 41 determines that the brightness region corresponding to the illuminance value read from the illuminance sensor 20 in step S11 is the same as or brighter than the brightness region corresponding to the previous illuminance value. Then, in step S13, the brightness value of the backlight for the main display 17 is set to a set value that is one level higher than the set value previously set as the brightness value of the backlight. For example, in status 14 of FIG. 7, the set value that is one level higher than set value 2 previously set in status 13 and associated in advance with brightness region B is set value 3. Therefore, the brightness value of the backlight for the main display 17 is set to set value 3 (as indicated by a black circle in status 14 of FIG. 7). In step S14, the brightness of the backlight for the main display 17 is controlled according to the set value set as the brightness value of the backlight in step S13.

If it is determined in step S15 that a predetermined time has elapsed, the process returns to step S3 and the steps following step S3 are repeated. That is, the current status of the cellular phone 1 is changed from status 14 to status 15 shown in FIG. 7. In status 15 of FIG. 7, the environment where the cellular phone 1 is used is darker than that in status 14.

Then, in step S3, an illuminance value is read from the illuminance sensor 20. For example, as shown in status 15 of FIG. 7, a brightness region corresponding to the illuminance value read from the illuminance sensor 20 is brightness region A (as indicated by a white circle in status 15 of FIG. 7).

Next, in step S4, it is determined whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 15 in FIG. 7, the illuminance value read from the illuminance sensor 20 in step S3 is less than or equal to reference value 1 and is included in brightness region A, which is darker than brightness region C in status 14 of FIG. 7. Then, since the illuminance value read from the illuminance sensor 20 in step S3 is smaller than the previous illuminance value, it is determined to be “NO” in step S4. Then, in the process of step S6 and step S7, the brightness value of the backlight for the main display 17 is set to set value 1 (as indicated by a black circle in status 15 of FIG. 7), and the brightness of the backlight for the main display 17 is controlled according to set value 1.

If it is determined in step S8 that a predetermined time has elapsed, the process returns to step S3 and the current status of the cellular phone 1 is changed from status 15 to status 16. In status 16 of FIG. 7, the environment where the cellular phone 1 is used is brighter than that in status 15. Then, as in the case of status 6 of FIG. 7, the process in steps S4, S9, S16, and S17 is performed, and the brightness value of the backlight for the main display 17 is set to set value 2 (as indicated by a black circle in status 16 of FIG. 7).

If it is determined in step S18 that a predetermined time has elapsed, the process returns to step S3 and the current status of the cellular phone 1 is changed from status 16 to status 17. Then, as in the case of status 13 and status 14 in FIG. 7, the process in steps S4, S5, and steps S10 to S14 is performed. That is, after the brightness value of the backlight for the main display 17 is temporarily maintained at set value 2 (as indicated by a black circle in status 17 of FIG. 7) and a predetermined time elapses, the brightness value of the backlight for the main display 17 is set to set value 3 (as indicated by a black circle in status 18 of FIG. 7).

If it is determined in step S15 that a predetermined time has elapsed, the process returns to step S3 and the steps following step S3 are repeated. That is, the current status of the cellular phone 1 is changed from status 18 to status 19 shown in FIG. 7, In status 19 of FIG. 7, the environment where the cellular phone 1 is used is darker than that in status 18. Then, in step S3, an illuminance value is read from the illuminance sensor 20. For example, as shown in status 19 of FIG. 7, a brightness region corresponding to the illuminance value read from the illuminance sensor 20 is brightness region B (as indicated by a white circle in status 19 of FIG. 7).

In status 19 of FIG. 7, the illuminance value read from the illuminance sensor 20 is greater than reference value 1 and less than or equal to reference value 2, and is included in brightness region B, which is darker than brightness region C in status 18 of FIG. 7. Then, since the illuminance value read from the illuminance sensor 20 in step S3 is smaller than the previous illuminance value, it is determined to be “NO” in step S4. Then, in the process of step S6 and step S7, the brightness value of the backlight for the main display 17 is set to set value 2, and the brightness of the backlight for the main display 17 is controlled according to set value 2.

If it is determined in step S8 that a predetermined time has elapsed, the process returns to step S3 and the steps following step S3 are repeated. That is, the current status of the cellular phone 1 is changed from status 19 to status 20 shown in FIG. 7. In status 20 of FIG. 7, the environment where the cellular phone 1 is used is brighter than that in status 19. Then, in step S3, an illuminance value is read from the illuminance sensor 20. For example, as shown in status 20 of FIG. 7, a brightness region corresponding to the illuminance value read from the illuminance sensor 20 is brightness region C (as indicated by a white circle in status 20 of FIG. 7).

Next, in step S4, the controller 41 determines whether the illuminance value read from the illuminance sensor 20 in step S3 is greater than the previous illuminance value, and whether the brightness region corresponding to the previous illuminance value and the brightness region corresponding to the illuminance value read in step S3 are different from each other. In the case of status 20 in FIG. 7, the illuminance value read from the illuminance sensor 20 is greater than reference value 2 and is included in brightness region C, which is brighter than brightness region B in status 19 of FIG. 7. That is, the brightness region (brightness region B) corresponding to the previous illuminance value and the brightness region (brightness region C) corresponding to the illuminance value read in step S3 are different from each other. Therefore, it is determined to be “YES” in step S4.

If it is determined in step S4 that the illuminance value read in step S3 is greater than the previous illuminance value and the brightness region corresponding to the previous illuminance value and the brightness region corresponding to the illuminance value read in step S3 are different from each other (“YES” in step S4), the process proceeds to step S9. In step S9, the controller 41 determines whether the brightness region corresponding to the previous illuminance value and the brightness region corresponding to the illuminance value read in step S3 are different from each other by two or more levels. For example, in the case of status 20 in FIG. 7, the brightness region corresponding to the previous illuminance value is brightness region B, while the brightness region corresponding to the illuminance value read in step S3 is brightness region C (that is, in the illuminance change, the illuminance value read in step S3 exceeds one of predetermined reference values set in advance (reference value 2), but the illuminance value read in step S3 does not exceed predetermined reference values set in advance by two or more reference values). Since brightness region B and brightness region C are not different from each other by two or more levels, the controller 41 determines in step S9 that the brightness region corresponding to the previous illuminance value and the brightness region corresponding to the illuminance value read in step S3 are not different from each other by two or more levels.

If it is determined in step S9 that the brightness region corresponding to the previous illuminance value and the brightness region corresponding to the illuminance value read in step S3 are not different from each other by two or more levels (“NO” in step S9), the process proceeds to step S10. In step S10, the controller 41 determines whether a predetermined time has elapsed. If it is determined in step S10 that the predetermined time has elapsed, the current status of the cellular phone 1 is changed from status 20 to status 21 shown in FIG. 7. Then, in step S11, the controller 41 reads, from the illuminance sensor 20, an illuminance value related to illuminance (brightness) in an environment where the cellular phone 1 is used. For example, as shown in status 21 of FIG. 7, a brightness region corresponding to the illuminance value read from the illuminance sensor 20 is brightness region B (as indicated by a white circle in status 21 of FIG. 7).

Then, in step S12, the controller 41 determines whether the brightness region corresponding to the illuminance value read from the illuminance sensor 20 in step S11 is the same as or brighter than the brightness region corresponding to the previous illuminance value. For example, in the case of status 21 in FIG. 7, the brightness region corresponding to the illuminance value read from the illuminance sensor 20 is brightness region B. Therefore, the controller 41 determines that the brightness region corresponding to the illuminance value read from the illuminance sensor 20 is not the same as or brighter than the brightness region corresponding to the previous illuminance value.

If it is determined in step S12 that the brightness region corresponding to the illuminance value read from the illuminance sensor 20 is not the same as or brighter than the brightness region corresponding to the previous illuminance value (“NO” in step S12), the process skips steps S13 and S14, and the brightness value of the backlight for the main display 17 is maintained at set value 2. Then, the process proceeds to step S15 and the steps following step S15 are repeated.

In the embodiment of the present invention described above, the illuminance sensor 20 detects illuminance in an environment where the cellular phone 1 is used. The controller 41 refers to a control table in which an illuminance value indicating illuminance in an environment where the cellular phone 1 is used and a set value related to a brightness value of the backlight for the liquid crystal display (main display 17) are associated with each other and registered in advance. Then, according to an illuminance value detected by the illuminance sensor 20 and indicating illuminance in an environment where the cellular phone 1 is used, the controller 41 sets a brightness value of the backlight turned on when the liquid crystal display displays an image to one of a plurality of set values. The controller 41 refers to the control table to determine whether the illuminance value detected this time by the illuminance sensor 20 is greater than the previous illuminance value previously detected by the illuminance sensor 20, and whether a brightness region corresponding to the previous illuminance value and a brightness value corresponding to the illuminance value detected this time are different from each other. If it is determined that the illuminance value detected this time is greater than the previous illuminance value and a brightness region corresponding to the previous illuminance value and a brightness value corresponding to the illuminance value detected this time are different from each other, the controller 41 controls, after a predetermined time elapses, the brightness of the backlight for the liquid crystal display according to one of the plurality of set values, the one being greater than a set value previously set as a brightness value of the backlight.

Thus, when the environment where the cellular phone 1 is used is changed to a bright environment, the timing for increasing the brightness of the backlight is delayed, while when the environment where the cellular phone 1 is used is changed to a dark environment, the brightness of the backlight is immediately reduced. Specifically, as shown in statuses 2 to 3, 7 to 9, 11 to 14, and 16 to 18 of FIG. 7, when the environment where the cellular phone 1 is used is changed to a bright environment (e.g., transition from brightness region A to brightness region B), the timing for increasing the brightness of the backlight is delayed; while on the other hand, as shown in statuses 4 to 5, 5, 10, 15, 19, and 21, when the environment where the cellular phone 1 is used is changed to a dark environment, the brightness of the backlight is immediately reduced.

Therefore, when the cellular phone 1 is often used in bright environments, the brightness of the backlight illuminating the backside of the liquid crystal panel can be prevented from being often increased to a maximum set value, and thus, an increase in power consumption associated with use of the backlight can be prevented. For example, in FIG. 7, the number of times the brightness of the backlight is set to a maximum value (set value 3 (level 3)) can be reduced to 4 times out of 12 times, which is the total number of times the illuminance in the environment where the cellular phone 1 is used is changed to that corresponding to brightness region C. Thus, power consumption can be reduced by the amount corresponding to 8 times, which is the number of times obtained by subtracting 4 times from 12 times.

In particular, when illuminance in the environment where the cellular phone 1 is used is often changed, such as in the case where the user takes a walk outside while receiving digital terrestrial broadcasting or the user uses e-mail on a subway train, the number of times the brightness of the backlight is set to a maximum set value is reduced. At the same time, when the environment where the cellular phone 1 is used is changed to a dark environment, the brightness of the backlight is immediately reduced. Thus, power consumption associated with use of the backlight can be sufficiently reduced. This makes it possible to preferably reduce power consumption of the liquid crystal display associated with use of the backlight.

In the embodiment of the present invention described above, the brightness of the backlight for the liquid crystal display is controlled in three stages. However, the present invention is not limited to this. For example, the present invention is applicable to the case where the brightness of the backlight for the liquid crystal display is controlled in multiple stages, such as four or more stages. When the brightness of the backlight is controlled in four stages, the brightness value of the backlight may be set, in step S13 of FIG. 5, to two or more levels higher than the previous set value. Then, if there is a sudden transition to a brightness region that is two or more levels brighter than the previous brightness region, the brightness value of the backlight may be set, in step S16 of FIG. 5, to two or more levels higher than the previous set value. Alternatively, the brightness of the backlight may be set according to the user's preference.

In the embodiment of the present invention described above, to prevent screen flicker that can occur when the user uses the liquid crystal display, the brightness of the backlight is controlled every predetermined time (e.g., 0.5, 1, or 2 seconds) in principle. However, in consideration of both user viewability of the screen and power consumption associated with use of the backlight, the predetermined time can be appropriately changed.

The present invention is applicable not only to the cellular phone 1, but also to other types of information processing apparatuses, such as a personal digital assistant (PDA), a personal computer, a portable game machine, a portable sound player, and a portable video player.

The series of processes described in the embodiment of the present invention can be performed either by software or hardware.

In the embodiment of the present invention described above, the steps in the flowchart are performed sequentially in order of description. However, the steps may be performed simultaneously or independently, and do not necessarily have to be performed sequentially.

What is claimed is:

1. An information processing apparatus comprising:
a liquid crystal display including a liquid crystal panel and a backlight;
a detecting unit configured to detect illuminance in an environment where the information processing apparatus is used;
a setting unit configured to set a brightness value of the backlight turned on when the liquid crystal display displays an image to one of a plurality of set values, on the basis of an illuminance value detected by the detecting unit; and
a control unit configured to control brightness of backlight on the basis of the set value set by the setting unit as the brightness value of the backlight,
wherein if an illuminance value detected by the detecting unit is greater than the previous illuminance value detected by the detecting unit and a brightness region corresponding to the previous illuminance value and a brightness region corresponding to the current illuminance value are different from each other and then a predetermined time elapses, the setting unit sets the brightness value of the backlight to a set value which is greater by at least one level than a set value in a previous setting processing.

2. The information processing apparatus according to claim 1, wherein the setting unit sets the brightness value of the backlight to one of a plurality of set values, on the basis of an illuminance value detected by the detecting unit, with reference to a control table in which brightness regions corresponding to illuminance values and set values related to the brightness value of the backlight are associated with each other and registered in advance.

3. The information processing apparatus according to claim 2, wherein brightness regions corresponding to illuminance values have at least two or more regions on the basis of one or plural predetermined reference values set in advance.

4. The information processing apparatus according to claim 1, wherein if an illuminance value detected by the detecting unit is greater than the previous illuminance value detected by the detecting unit and the brightness region corresponding to the previous illuminance value and the brightness region corresponding to the current illuminance value are different from each other, the setting unit maintains the set value in the previous setting processing until the predetermined time elapses.

5. The information processing apparatus according to claim 1, wherein if an illuminance value detected by the detecting unit is smaller than the previous illuminance value, or if an illuminance value detected by the detecting unit is greater than the previous illuminance value but the brightness region corresponding to the previous illuminance value and the brightness region corresponding to the current illuminance value are the same, the setting unit sets the brightness value of the backlight to a set value which is associated with the brightness region corresponding to an illuminance value detected by the detecting unit, before the predetermined time elapses.

6. The information processing apparatus according to claim 1, wherein in a case where an illuminance value detected by the detecting unit is smaller than the previous illuminance value, or if an illuminance value detected by the detecting unit is greater than the previous illuminance value but the brightness region corresponding to the previous illuminance value and the brightness region corresponding to the current illuminance value are the same, if a set value related to the brightness value of the backlight and associated in advance with the brightness region in which an illuminance value detected by the detecting unit is included is greater than a set value set by the setting unit, and then a predetermined time elapses, the setting unit sets the brightness value of the backlight to a set value which is greater by at least one level than the set value in the previous setting processing.

7. The information processing apparatus according to claim 6, wherein after the predetermined time elapses, an illuminance value detected by the detecting unit is included in the brightness region corresponding to the previous illuminance value or in a brightness region brighter than the brightness region corresponding to the previous illuminance value, the setting unit sets the brightness value of the backlight to a set value which is greater by at least one level than the set value in the previous setting processing.

8. The information processing apparatus according to claim 6, wherein if after the predetermined time elapses, an illuminance value detected by the detecting unit is included in a brightness region darker than the brightness region corresponding to the previous illuminance value, the setting unit maintains the set value in the previous setting processing.

9. The information processing apparatus according to claim 1, wherein if an illuminance value detected by the detecting unit is greater than the previous illuminance value and the brightness region corresponding to the previous illuminance value and the brightness region corresponding to the current illuminance value are different from each other by two or more levels, the setting unit sets the brightness value of the backlight to a set value which is greater by at least one level than the set value in the previous setting processing before the predetermined time elapses.

10. The information processing apparatus according to claim 1, wherein in a case where an illuminance value detected by the detecting unit is greater than the previous illuminance value detected by the detecting unit and the brightness region corresponding to the previous illuminance value and the brightness region corresponding to the current illuminance value are different from each other, if after the predetermined time elapses, an illuminance value detected by the detecting unit is included in the brightness region corresponding to the previous illuminance value or in a brightness region brighter than the brightness region corresponding to the previous illuminance value, the setting unit sets the brightness value of the backlight to a set value which is greater by at least one level than the set value in the previous setting processing.

11. The information processing apparatus according to claim 1, wherein in a case where an illuminance value detected by the detecting unit is greater than the previous illuminance value detected by the detecting unit and the brightness region corresponding to the previous illuminance value and the brightness region corresponding to the current illuminance value are different from each other, if after the predetermined time elapses, the illuminance value detected by the detecting unit is included in a brightness region darker than the brightness region corresponding to the previous illuminance value, the setting unit maintains the set value in the previous setting processing.

12. An information processing apparatus comprising:
a liquid crystal display including a liquid crystal panel and a backlight;
a detecting configured to detect illuminance in an environment where the information processing apparatus is used;
a setting unit configured to set a brightness value of the backlight turned on when the liquid crystal display displays an image to one of a plurality of set values, on the basis of an illuminance value detected by the detecting unit, with reference to a control table in which brightness regions corresponding to the illuminance value and set values related to the brightness value of the backlight are associated with each other and registered in advance; and
a control unit configured to control brightness of backlight on the basis of the set value set by the setting unit as the brightness value of the backlight,
wherein the control unit delays a process of controlling the brightness of the backlight by a predetermined time, on the basis of an illuminance value detected by the detecting unit, if the environment where the information processing apparatus is used is changed to a bright environment.

13. The information processing apparatus according to claim 12, wherein the control unit controls brightness of backlight without delaying a process of controlling the brightness of the backlight by the predetermined time, if the environment where the information processing apparatus is used is changed to a dark environment.
